(19) United States
(12) Patent Application Publication
(10) Pub. No.: US 2006/0115614 A1
(43) Pub. Date: Jun. 1, 2006

(54) Process for finishing the surface of an article and article thus obtained

(76) Inventor: Giuseppe Raia, Torino (IT)

Correspondence Address: NOVAK DRUCE DELUCA & QUIGG, LLP, 1300 EYE STREET NW, SUITE 400 EAST, WASHINGTON, DC, 20005, US

(21) Appl. No.: 10/540,155

(22) PCT Filed: Dec. 23, 2003
(86) PCT No.: PCT/IB03/06155

§ 371 Date: Jun. 21, 2005

(30) Foreign Application Priority Data
Dec. 24, 2002 (IT) TO2002 A 001117
Dec. 24, 2002 (IT) TO2002 U 000227

(51) Int. Cl. B60R 21/16

(52) U.S. Cl. 428/36.1; 427/475; 427/180

(57) ABSTRACT

In the process according to the invention, an article is subjected to a surface finishing operation by means of flocking treatment, avoiding any painting, polishing, smoothing and/or similar operations. The flocking operation essential consists of a superficial laying of natural and/or synthetic fibres or microfibres on the article to be finished, previously coated with adhesive or the like. The building and furnishing article, obtained from recycled materials by means of the process according to the invention, has a surface coating formed by a uniform layer of fibres or microfibres fixed to the article itself and constituting a covering jacket.

The present invention relates to a surface finishing process for building and furnishing articles, in particular obtained from recycled materials. The invention also relates to the article obtained by said process.

Some examples of building and furnishing articles are: window and door frames, windows and doors, curtains, matchboards, dividing elements, panels, furniture and the like. However, the invention finds application with respect to any article obtained from recycled materials and used for building and furnishing purposes.

Use of articles obtained from recycled materials, such as plastics, cardboard, pressed wood and the like, is highly positive, but oftentimes the superficial appearance of such articles does not allow their widespread use in the building and furnishing industries.

The surface of such articles is often unappealing to sight and/or touch, because of the colour and/or of the irregularity of their surface, which sometimes not even painting can hide.

Moreover, some such articles used in the building and furnishing industries have at least one of the following drawbacks:
they easily collect on their surface the water vapour condensation present in the space and release it in the form of drops, in uncontrolled fashion;
they reflect light radiation that strikes them, at times in an annoying manner;
they propagate the sound waves that are diffused in the space, increasing the background noise level;
though they do provide a barrier to the exchange of heat between the inner environment and the outer environment, they are nonetheless “cold” to sight and touch;
they are occasionally superficially finished by means of painting or the like, but said surface finish is often insufficient to hide their visible surface defects;
they cannot provide the environment with any protection against dust;
they have no aptitude for furnishing spaces, even when they are superficially finished by painting or the like.

On the other hand, it is relatively difficult to have available, in the building and furnishing industries, articles able to constitute barriers against electromagnetic radiation, which nonetheless have a pleasing superficial appearance, suitable for furnishing spaces.

The present invention, starting from the notion of said drawbacks, aims to overcome them.

Therefore, an object of the present invention is to provide a surface finishing process for a building and furnishing article, obtained from recycled materials, which allows to provide said articles with an appealing and finished surface appearance.

Another object of the invention is to provide a process as specified, which is simple and economical to implement.

A further object of the invention is to obtain, by implementing the above process, a building and furnishing article, obtained from recycled materials, which has an appealing and finished appearance and which has one or more of the properties of refraining the dropping of water vapour condensation, glare prevention, noise abatement, appearing “warm” to the touch and/or sight, having a surface finish capable of covering any apparent flaws, providing protection against dust, which make it suitable for furnishing spaces.

Yet another object of the invention is to provide, by means of the aforesaid process, an article able to constitute a barrier against electromagnetic radiation and which nonetheless has a pleasing surface appearance, suitable for furnishing spaces.

An additional object of the invention is to provide an article as specified, which is simple and economical to obtain.

In view of these objects, the present invention provides a surface finishing process for building or furnishing articles, obtained from recycled materials, whose main characteristic is set out in claim 1.

The invention further provides an article obtained with the aforesaid process, whose essential characteristic is set out in claim 8.

Additional advantageous characteristics are described in the dependent claims.

The aforesaid claims are understood to be integrally set out herein.

According to the present invention, an article obtained from recycled materials, in particular for building and furnishing purposes, is subjected, at the end of the productive process, to a surface finishing operation by flocking, treatment, thereby avoiding any painting, polishing, smoothing and/or similar operations.

Said flocking operation essentially consists of a superficial deposition of natural and/or synthetic fibres or microfibres on the article to be finished, previously coated with adhesive or the like.

Flocking is carried out with an electrostatic process which uniformly distributes on the article to be superficially coated the coating fibres or microfibres.

The fibres used in this process, commercially known by the name of flock fibres or microfibres, can for instance be of ground cotton, ground rayon (trade name), ground nylon (trade name), ground polyester, and so on. Flock fibres or microfibres can be glossy, semi-glossy, opaque, semi-opaque, transparent, semi-transparent, three-lobed.

To the touch and sight, the surface coating of flock fibres or microfibres has the following characteristics, depending on the length of the fibre or microfibre in use:
short fibre→deer skin or alcantara effect;
medium-short fibre→plush effect;
medium-long fibre→velvet effect;
long fibre→fur effect.

Flock fibres or microfibres can have any colour and length and combinations of fibres of different colours and/or lengths can also be used, in order to provide the effect of mixing colours and/or lengths.

The following table provides some examples of flock fibres or microfibres, useful for the purposes of the present invention. The unit of measure of the count (diameter) of the fibre is Dtex.

TABLE 1

| Flock type | Dtex | Lustre | Length |
|---|---|---|---|
| Rayon Flock | 0.75 to 3.3 | glossy to opaque | 0.3 to 4.0 mm |
| Nylon Flock | 0.9 to 1.7 | semi-opaque/opaque | 0.5 to 4.0 mm |
| Polyester Flock | 3.3 | glossy | 0.4 to 1.0 mm |

Moreover, according to the present invention, the flocking operation can be performed applying transparent, semi-transparent, three-lobed or translucent on the surface of the article to be coated, previously provided with a decorative pattern, for instance by means of serigraphy or pad printing, and which is then visible through the flocking surface coating, obtaining an ornamental decorative appearance with shaded drawing with effect, for instance, similar to satin, embroidery, pattern and the like.

It should be noted that the articles to be treaded with the process according to the invention can be made of any recycled material, such as synthetic resin, wood, metal, elastomer, cardboard, and so on.

The building and furnishing article, obtained by the process according to the invention, such a window or door frame, a window or door, a curtain, a matchboard, an interior divider, a frame, a piece of furniture and the like, has a surface coating formed by a uniform layer of flock fibres or microfibres fixed to the article and constituting and covering jacket. It has at least of the following main advantages:
it has good anti-dripping properties with respect to vapour condensation which accumulates thereon;
has good anti-glare properties with respect to light radiation which strikes it;
it has good sound-absorbing properties with respect to the sound waves which strike it;
it provides an appealing “warm” effect to the touch and sight;
it has a surface finish that effectively hides the flaws, which otherwise would be visible on the surface;
it has a significant aptitude for protecting the space against dust;
it has its own aptitude for furnishing the space, allowing personalised, original furnishing solutions;
it is recyclable and easy to maintain.

This article also forms an effective barrier against electromagnetic radiation, whilst exhibiting an appealing surface appearance, suitable for furnishing spaces.

The present invention shall become more readily apparent from the detailed description that follows, with reference to the accompanying drawings, provided purely by way of non limiting example, in which:

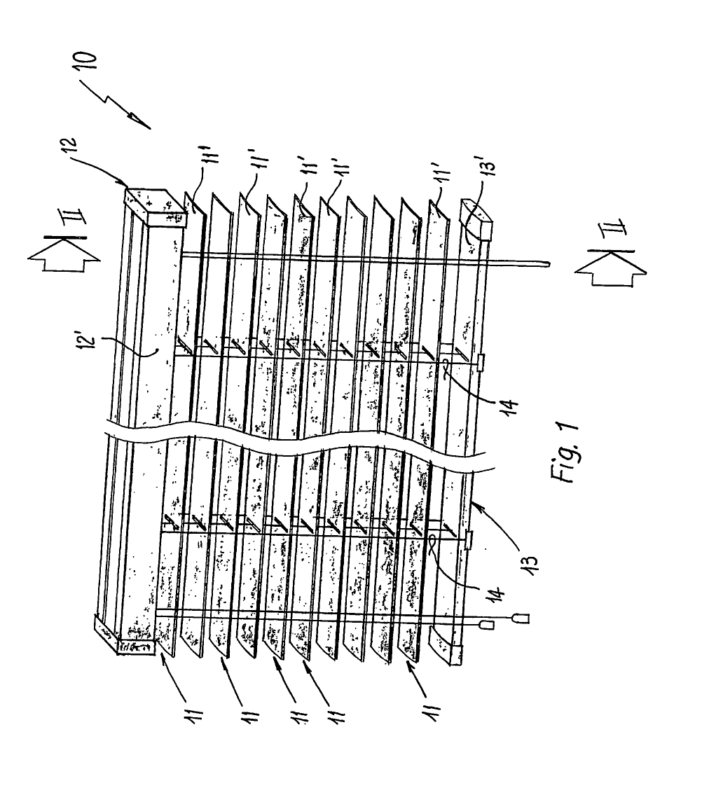

FIG. 1 is a partial perspective view of a Venetian blind according to the principles of the present invention;

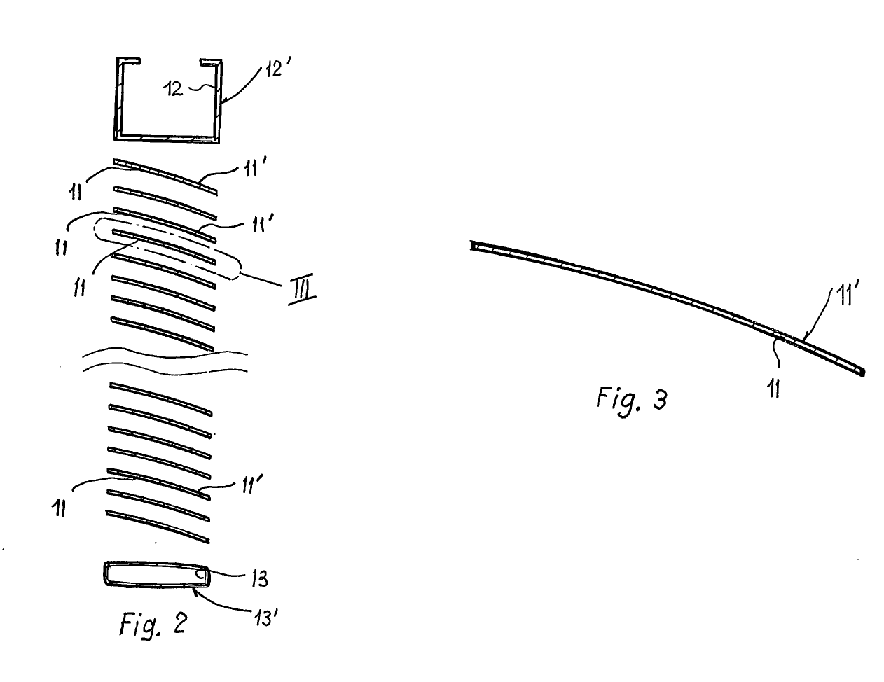

FIG. 2 is a partial, sectioned and enlarged view according to the line II-II of FIG. 1;

FIG. 3 is a detailed view, in enlarged scale, of the component III of FIG. 2;

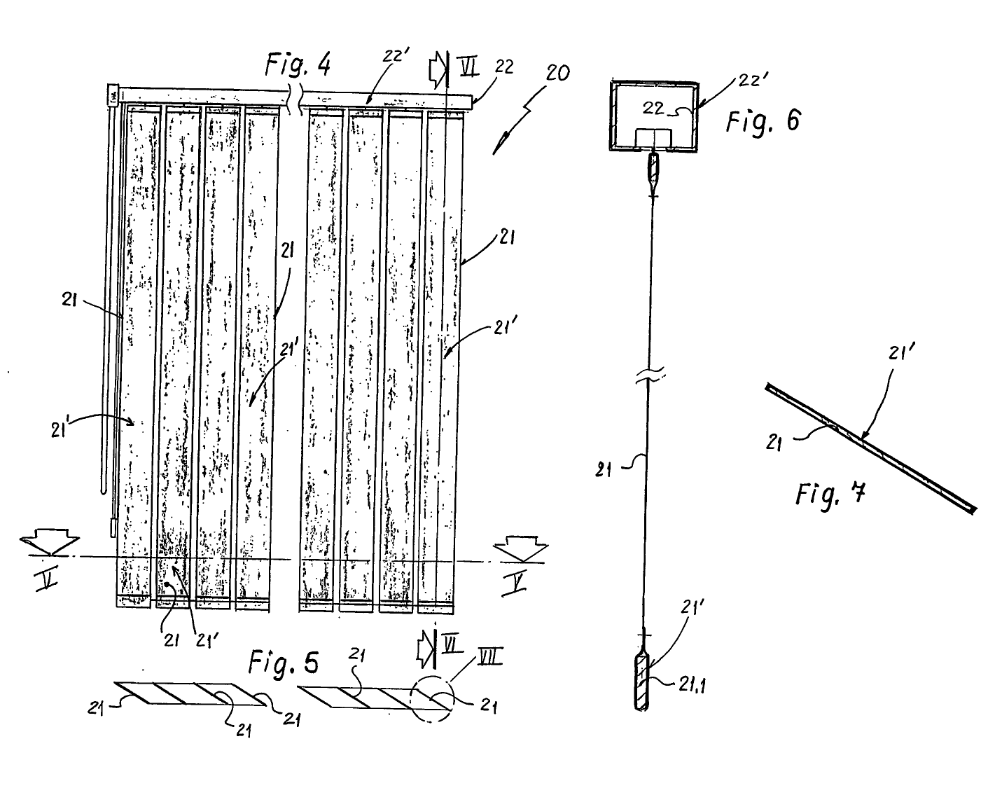

FIG. 4 is a partial elevation view of a vertical curtain according to the principles of the present invention;

FIG. 5 is a partial section view according to the line V-V of FIG. 4;

FIG. 6 is a partial section view, in enlarged scale, according to the line VI-VI of FIG. 4;

FIG. 7 is a detailed view, in enlarged scale, of the component VII of FIG. 5;

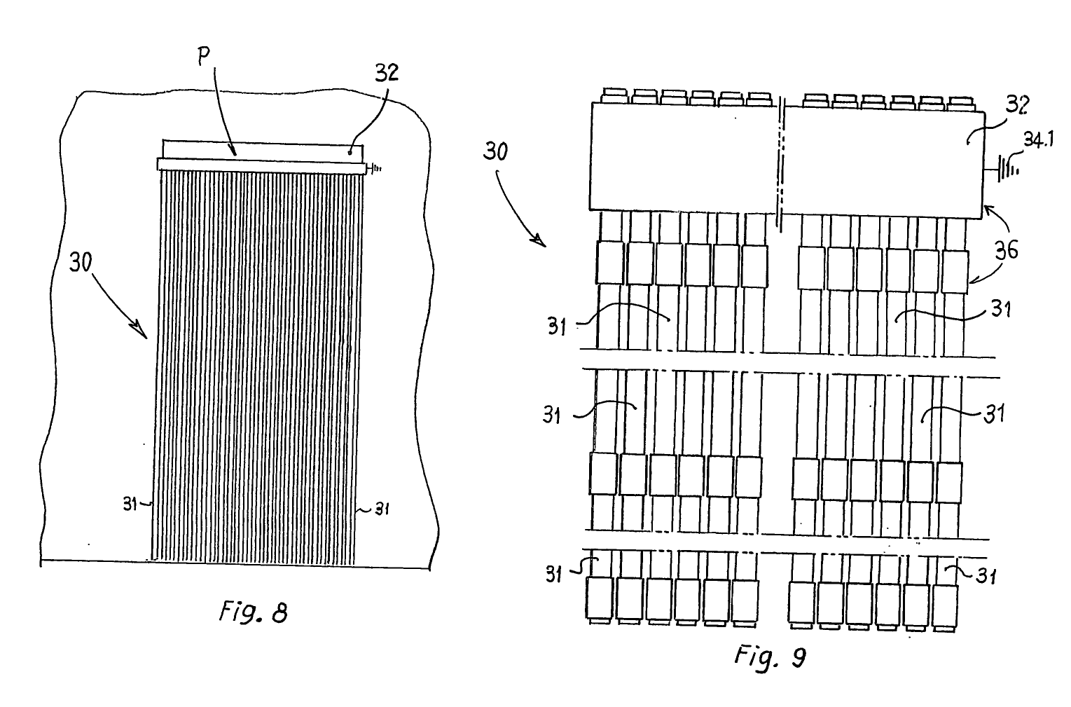

FIG. 8 is an elevation view of a curtain with hanging flexible strings provided with means for dispersing electromagnetic radiation and finished with a flocking surface finish layer, according to the invention;

FIG. 9 is a detailed, enlarged and partially sectioned view of FIG. 8;

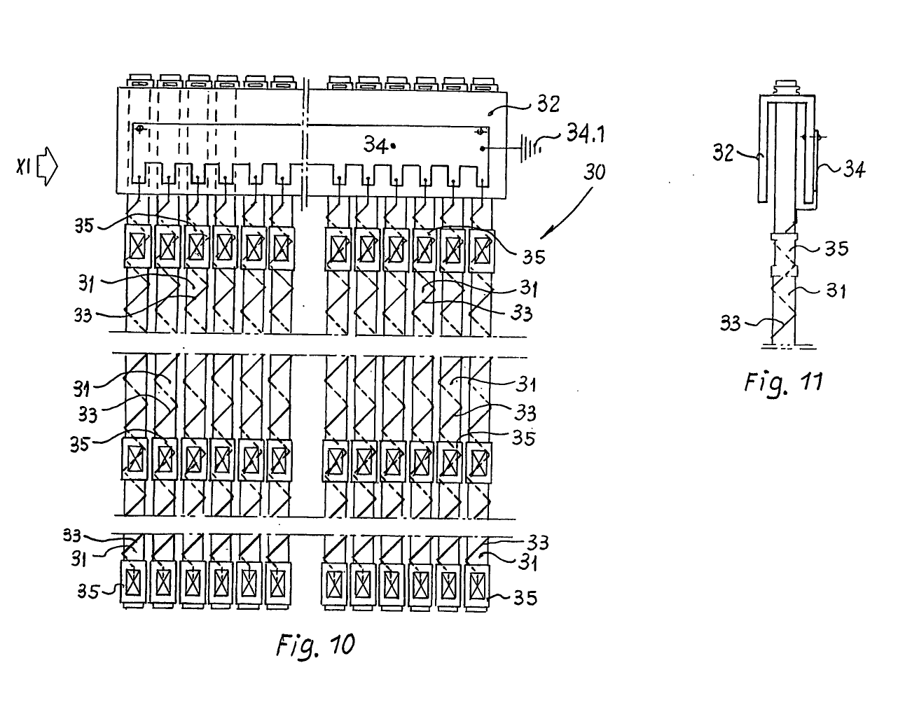

FIG. 10 shows the curtain of FIG. 9 without the surface finish layer obtained by flocking;

FIG. 11 is a partial view in the direction of the arrow XI of FIG. 10.

With reference first of all to FIGS. 1 through 3 of the drawings, the number 10 globally designates a Venetian blind according to the invention.

The blind 10 comprises a plurality of essentially horizontal strips 11, mutually equidistant and suspended relative to an upper container 12 with box body, whilst a lower bar 13 maintains under tension, by gravity, a plurality of string organs 14, connecting the strips 11 to each other and with respect to the container 12.

According to the present invention, substantially all elements of the Venetian blind 10 have a surface coating, respectively designated 11′, 12′, 13′ for said elements 11, 12 and 13, formed by a uniform layer of fibres or microflbres fixed to the elements and constituting a coating jacket.

Said surface coating 11′, 12′, 13′ of the elements 11, 12, 13 of the blind 10 is constituted by a surface deposition of natural and/or synthetic fibres or microfibres on the related element, previously coated with adhesive or the like, and this by means of a flocking surface treatment.

With reference now to FIGS. 4 through 7, the number 20 globally designates a so-called vertical curtain, comprising a plurality of vertical strips 21, mutually parallel and side by side, suspended relative to an upper container 22, with box body, each of which is maintained under correct tension by means of a respective gravity body 21.1. Said strips 21 are constituted, for example, by flexible bands of textile material, or by flexible laminas made of synthetic resin or metal.

According to the present invention both the strips 21 and the upper box 22 of the vertical blind 20 have a surface coating, respectively designated by the references 21′, 22′, formed by a uniform layer of flock fibres or microflbres fixed to the elements and constituting a coating jacket.

With reference to FIGS. 8 through 11, the number 30 designates a curtain with hanging flexible strings positioned to cover the opening of the door P.

Said curtain 30 comprises a plurality of hanging strings 31 made of synthetic resin, for instance nylon, suspended superiorly with respect to a linear bar support 32, formed by an upside down “U” shaped section bar made of synthetic resin and in turn fastened with respect to the wall in which the door P is positioned, in proximity to the top of the door itself.

Each hanging string 31 bears a metallic wire 33, constituting a good electrical conductor, wound in helical fashion along its surface and electrically connected to the top with respect to a metal plate 34, shaped as a comb and fastened on an outer face of said bar support 32. Said comb shaped plate 34 is in turn electrically grounded (in 34.1) in order to establish an electrical connection between the curtain 30 and the ground. A plurality of small lead bushings 35 are fitted, at intervals, on each hanging string 31 and on the related conducting metallic wire 33 superposed and are crushed in such a way as to fasten the conductor 33 on the hanging string 31 and to provide a fixed gravity mass acting on the string 31.

The curtain 30 thereby forms a barrier able to dissipate electromagnetic radiation.

Said curtain 30 has a surface coating 36, formed by a uniform layer of fibres or microfibres fixed to all its elements and constituting a covering jacket. It should be noted that in FIGS. 10, 11 the curtain 30 is shown in the unfinished state, I.e. prior to the surface finish by means of the flocking layer 36 of all its components, whilst in FIGS. 8 and 9 said curtain 30 is shown finished, i.e. coated in all its components by means of said surface coating 36, obtained by flocking and forming a covering jacket.

It should also be noted that the flocking layer 36 forms on the hanging strings 31 a hair coating (not shown in the drawings), which forms an excellent barrier against the passage of flying insects, such as flies.

The characteristics of the fibres used to obtain the curtain 10, 20 and 30 are Illustrated above, with reference to the process according to the invention.

The curtain 10, 20 or 30, whose elements have the surface coating constituted by a uniform layer of flock fibres or microfibres constituting a covering jacket, according to the invention, have the main advantages listed above.

It should be noted that, by means of the covering jacket surface coating made of transparent, semi-transparent, three-lobed or translucent flock fibres or microfibres one can obtain also on coated structures an ornamental decorative effect with shaded drawing, previously providing the surface to be coated with an actual drawing, for instance by means of serigraphy or pad printing, which is then visible through the covering jacket coating with an effect, for instance, similar to satin, embroidery, pattern and the like.

Moreover, surface coatings of flock fibres or microfibres are easily maintained and If damaged they can be restored to their original condition in relatively simple and economical fashion. They are recyclable.

As is readily apparent, any structure of window or door frame, window or door, curtain, matchboard, doors and interior dividers, frames, furniture items and the like for building and furnishing, can be provided with the surface coating with covering jacket of flock fibres or microfibres, according to the present invention, achieving the technical advantages set out above.

It should also be noted that said structures can be made of any material, such as synthetic resin, wood, metal, rubber, cardboard, plasterboard, and so on.

1. A surface finishing process for building and furnishing articles, obtained from recycled materials, characterized in that said article is subjected to a surface finishing operation by a flocking treatment, avoiding any painting, polishing, smoothing and/or similar operations.

2. The process as claimed in claim 1, characterized in that the flocking operation essentially consists of a superficial deposition of natural and/or synthetic fibers or microfibers on the article to be finished, previously coated with adhesive or the like.

3. The process as claimed in claim 1, characterized in that the flocking operation is carried out by an electrostatic process which uniformly distributes coating fibers or microfibers on the article to be superficially coated.

4. The process as claimed in claim 2, characterized in that the fibers or microfibers are glossy, semi-glossy, opaque, semi-opaque, transparent, three-lobed and/or semi-transparent.

5. The process as claimed in claim 2, characterized in that, to the touch and sight, the coating flock fibers or microfibers have the following characteristics, depending on the length of the fiber or microfiber in use:
short fiber→deer skin or alcantara effect;
medium-short fiber→plush effect;
medium-long fiber→velvet effect;
long fiber→fur effect.

6. The process as claimed in claim 2, characterized in that the coating flock fibers or microfibers can have any color and length and/or combination of colors and/or lengths.

7. The process as claimed in claim 1, characterized in that transparent, semi-transparent, three-lobed and/or translucent fibers or microfibers are fixed on the surface of the article to be coated, previously provided with a decorative pattern, which is then visible through the flocking surface coating, obtaining an ornamental decorative appearance with shaded drawing with effect, for instance, similar to satin, embroidery, pattern and the like.

8. A building and furnishing article, obtained from recycled materials by the process as claimed in claim 1, characterized in that it has a surface coating (11′, 12′, 13′; 21′, 22′; 36), formed by a uniform layer of fibers or microfibers fixed to the elements themselves and constituting a covering jacket.

9. The building and furnishing article as claimed in claim 8, characterized in that said covering jacket surface coating (11′, 12′, 13′; 21′, 22′; 36) is constituted by laying natural and/or synthetic fibers or microfibers on its surface, previously coated with adhesive or the like, and this by a flocking surface treatment.

10. The building and furnishing article as claimed in claim 8, characterized in that said fibers or microfibers are glossy, semi-glossy, opaque, semi-opaque, transparent, semi-transparent, three-lobed.

11. The building and furnishing article as claimed in claim 8, characterized in that said covering jacket surface coating of fibers or microfibers (11′, 12′, 13′; 21′, 22′; 36) exhibits, when touched, the following characteristics, depending on the length of the fiber or microfiber in use:
short fiber or microfiber→deer skin or alcantara effect;
medium-short fiber→plush effect;
medium-long fiber→velvet effect;
long fiber→fur effect.

12. The building and furnishing article as claimed in claim 8, characterized in that said covering jacket surface coating of fibers or microfibers (11′, 12′, 13′; 21′, 22′; 36) includes fibers or microfibers of any color and/or lengths, combinations of fibers of different colors and/or lengths being usable as well, to provide an effect of mixed colors and/or lengths.

13. The building and furnishing article as claimed in claim 8, characterized in that said coveting jacket surface coating is made of transparent, semi-transparent, three-lobed or translucent fibers or microfibers and provides an ornamental decorative effect with shaded drawing, which is previously obtained on the surface to be coated and is visible through said covering jacket surface coating with effect, for instance, similar to satin, embroidery, pattern and the like.
